(19) United States
(12) Patent Application Publication
(10) Pub. No.: US 2005/0257883 A1
(43) Pub. Date: Nov. 24, 2005

(54) Method of construction of mattresses from mass produced and simultaneously pocket encapsulated springs and mattress produced by this method

(76) Inventor: Panagiotis Anagnostopoulos, Athens (GR)

Correspondence Address: BAKER & DANIELS LLP;111 E. WAYNE STREET, SUITE 800, FORT WAYNE, IN, 46802, US

(21) Appl. No.: 10/523,947

(22) PCT Filed: Aug. 7, 2003
(86) PCT No.: PCT/GR03/00034

§ 371 Date: May 5, 2005

(30) Foreign Application Priority Data
Aug. 12, 2002 (GR) 020100377

(51) Int. Cl. B32B 31/00

(52) U.S. Cl. 156/290; 156/308.4; 5/716

(57) ABSTRACT

The present invention refers to a method of producing innerspring mattress units made of springs encapsulated in a woven or non woven sheet, where the whole row of springs needed for the constructed side of the mattress is produced simultaneously by an equal number to the springs spring coiler machines. The invention also refers to a mattress made of springs encapsulated into pockets.

### TECHNICAL SCOPE OF THE INVENTION

The present invention refers to a method and a system of mass production of springs for the assembly of mattresses (4), where the springs are produced from spring forming coilers, which are equal in number to the springs necessary to construct each side of the mattress, which springs are encapsulated simultaneously inside formed pockets (2) made of woven or non woven sheets of mattress material.

The woven or the non woven sheet (5) is shaped into continuous rows of pockets (2) between which pockets there exist connections (7, 8) and within which pockets (2) the springs (1) are positioned. The springs (1) are encapsulated within the pockets (2) as a result of the formation of joints (7, 8), as depicted in FIG. 3. In this fashion strips (3) of springs are created that are connected between them at the middle sections of the formed pockets with connections (19) composing thus the mattress (4), as shown in FIG. 5.

The innerspring mattress is created by strips (3) of springs that have lengths equal to one of the dimensions of the innerspring mattress and are connected between them in parallel until the other desirable dimension of the innerspring unit is accomplished.

### STATE OF THE ART

The method that is presented here describes a method of production for this type of an innerspring mattress, which when compared to existing methods, is more productive, more economical and integrates in one machine a series of process stages for the production of the innerspring mattress.

The usual method employed for constructing innerspring mattresses made of springs encapsulated in woven or non woven mattress material, involves the serial production of springs and their subsequent serial encapsulation in strips of springs of large lengths. Subsequently, the strips are fed to another machine, where they are cut to the desired length and are connected between them, so as to form the innerspring mattress.

Patents WO0198151, WO9950175, EP1192884 A, EP0967031 A2 and WO9925647 describe methods and spring machines that encapsulate springs in strips of woven or non woven sheets. In all instances, the springs are produced one by one and are situated inside a strip of woven or non woven sheet. This strip is suitably folded up and the necessary welds are done on its surface, so as to form pockets with encapsulated springs. This process produces a continuous strip of encapsulated springs of large length. In some instances the springs undergo thermal processing and in other instances not.

The strip of the encapsulated springs that has been produced with the above manner comprises the building block element for innerspring mattress units. The traditional construction method used for these innerspring units is the manual assembly. According to this method, the strips are cut to the desired length, they are placed next to one another and held between them by stitched threads that run the length of one dimension of the unit, at the middle section of the strip.

Various automatic methods and machines have been presented in inventions DE4303089, EP0624545, WO9737569, EP0764608 B1, EP0155158 A2 and WO0055088.

The basic principle upon which the above inventions are based on is summarized in the following procedure: 1. A new strip of springs is cut to the desired length. 2. Hot melt adhesive is deposited on the previously processed strip. 3. A new strip is pressed towards the constructed portion of the mattress, so that it can bond with the previously produced strips of springs and as to compose part of the mattress.

The disadvantage of all the methods aforementioned is that their productivity is restricted in the aspect that all the springs necessary are produced by only one spring coiler machine.

The objective of the present invention is to construct a machine that can multiply the productivity offered by existing machines, that can offer flexibility in changing the type of springs produced, the spring diameter, also automatic production of zones of different rigidity in the mattress, a capability to use as the encapsulating pocket material woven or non woven sheets and also to be able to create in the same mattress zones and layers of different rigidity that correspond to the respective rigidity characteristics found in submattress, mattress and top mattress composite structures.

### PRESENTATION OF THE FIGURES

FIG. 1: Typical innerspring mattress made of strips of pocketed springs.

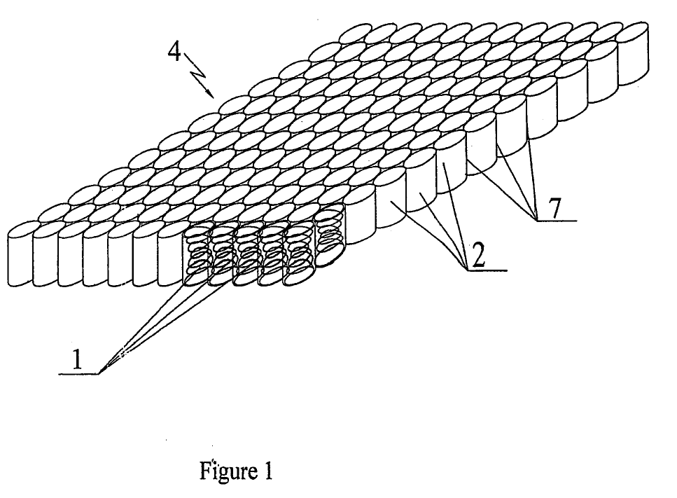

FIG. 2: Strip of pocketed springs.

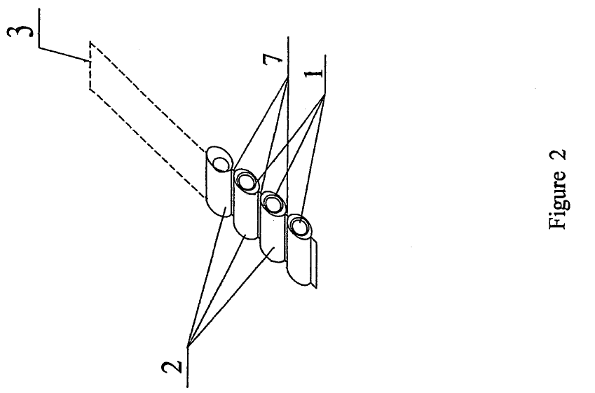

FIG. 3: Process steps to encapsulate all the springs of a whole mattress row into folded mattress making material so as to form pocket spring strips.

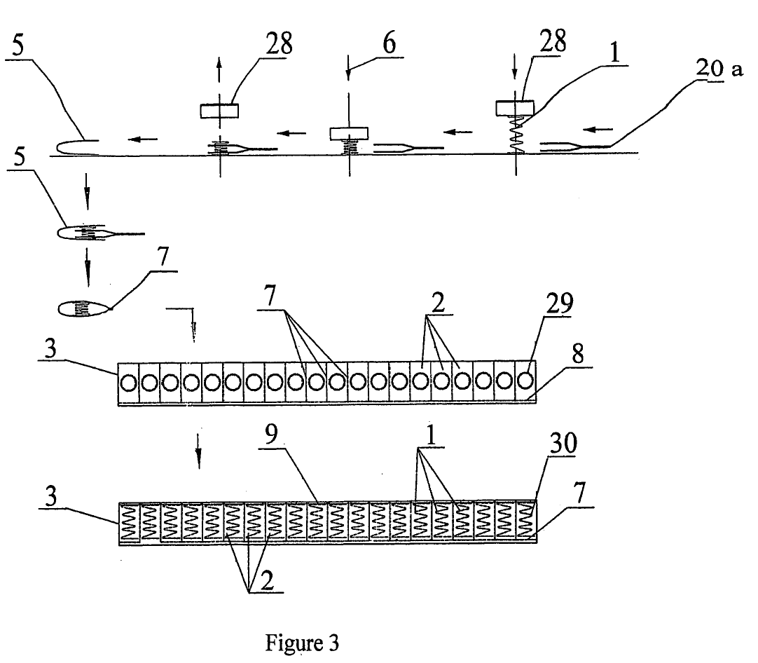

FIG. 4. Formation of spring diameter and pitch from raw wire.

FIG. 5: Assembly of mattress by adhering strip upon strip.

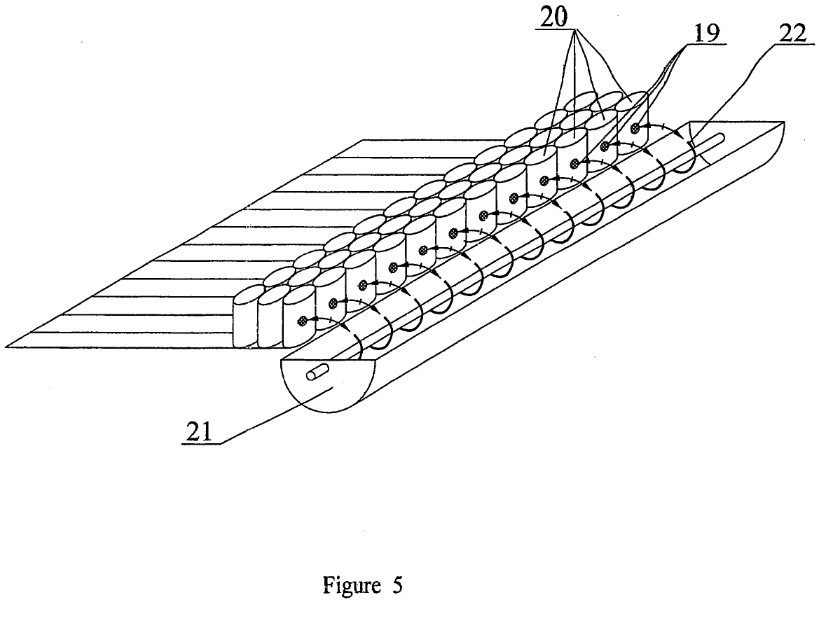

FIG. 6: Multi layer rigidity spring.

FIG. 7: Open ended pocketed spring.

FIG. 8: Attachment details of spring turn on the pocket sidewalls.

### REVELATION OF THE INNOVATION

The present invention includes the following innovative applications:

All the springs (1) that are needed to be encapsulated within the pockets (2) of a strip (3) corresponding to the length of the side of mattress being created are produced simultaneously one row configuration at a time.

For each single spring position in the strip there is a separate spring coiler producing machine. Typically the number of spring coilers can reach one hundred (100) when mattresses are produced that are composed of small diameter springs.

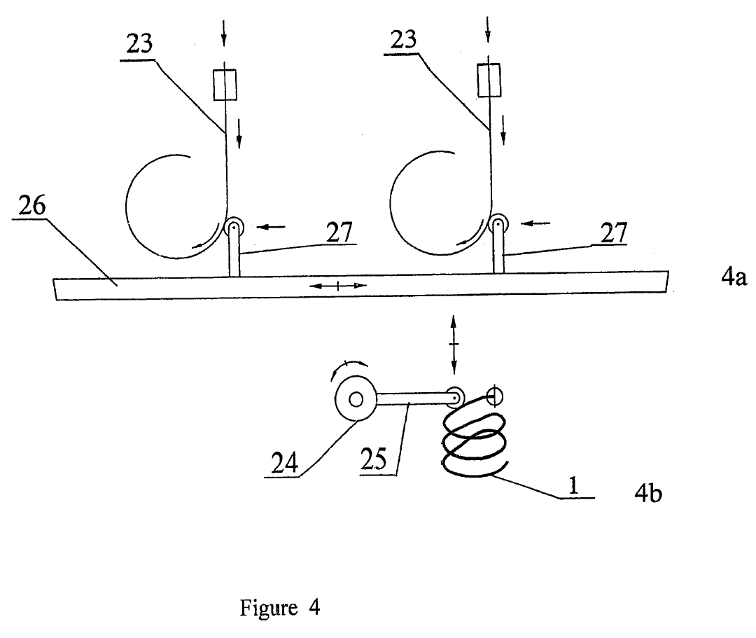

The spring coilers have concurrent operation, a common motor source, a common adjustment mechanism to form the shape, the number of spring turns and the pitch of the springs (FIG. 4).

They have a common source to pull the wire material through and to cut it off. The wire pull and advance rollers of each wire acquire motion from a common lengthwise axle.

There is also a thermally conditioned space to thermally process all the produced springs as a group.

The necessitated pressure exerted between the rollers so as to attract the wire is applied by air or oil cylinders that have a common source, but separate valves for each one.

Thus, through the computer a command is activated as to which cylinders are to be energized each time, depending on how many springs need to be produced for the processed side of the mattress.

For forming the diameter of the springs, there is a lengthwise bar (26) that bears an equal in number to the springs sets of arms (27), and by the bar motion the exiting wire is appropriately pushed, thus forming the common spring diameter. Also, there is a respective lengthwise bar (24) that has a respective number of arms (25) that compress simultaneously the spring turns of the produced springs thus forming a common pitch. In addition, each spring coiler has a mechanism to cut the formed springs.

The cutting action is simultaneous in all spring forming positions either in the form of a common mechanical motion or through a common hydraulic pressure.

In the mechanical motion case, an analogous lengthwise bar with respective cutting arms severes by revolution or by lengthwise movement the springs.

When utilizing oil pressure, each spring forming coiler machine incorporates a hydraulic cutter.

Thermal processing of the springs when necessary after the spring formation, takes place inside a thermally conditioned closed space through which pass the springs in arrangements of rows moving parallel to one another in the fashion that they are formed.

Other preexisting machines warm up the springs with electrodes. This though renders impossible the capability to be able to process diameters ranging possibly from 70 mm to 20 mm. In order to thermally process each single spring its upper spring turn has to be gripped by two forklike electrode mechanisms and likewise for the lower spring turn. With the usage though of a thermal conditioning chamber, there is no size restriction with respect to spring size processed and the associated costs are much less than a hundred (100) simultaneously operating electrical annealing devices.

After the thermal processing stage area, the springs after being cooled down are forced to approach one another as much as necessary depending on their diameter. This is achieved in the following manner:

Each spring as well as the ones that follow it, being produced by the same spring coiler, is being transported towards its encapsulation position into pockets via a separate independent moving linear transport belt that has a certain length. This belt can rotate about its one end, about the position that the spring occupied at its initial inter-distance state. Its other end can move to approach or recede from neighboring transport belts. Thus it can be situated wherever needed so as to bring each spring to its new position.

Subsequently, the whole row of springs is compressed (6) with a suitable mechanism (28), so that the springs are completely compressed. Then they are picked up by a respective lengthwise mechanism (20a) that holds them compressed and leads them between the open ends of the folded fabric (5) from which the strip (3) is fabricated. It is possible for the mattress-making material to be folded up along its length, about its middle width axis driven by the lengthwise spring transport system. At that position the springs are situated between them at the desired distances that they will have in the constructed strip.

The sheet that is used to encapsulate the springs (1) and to form the strip (3) can be woven or thermally weldable non woven. The creation of the strips is done as follows:

The fabric strip enters the work area where it will encapsulate the springs moving along the direction of its width that is usually 30 to 50 cm long. It is possible though to come there also along its length direction, traveling in such a case about 300 cm.

When the row with the compressed springs enters in between the folded mattress material side, the encapsulation process can commence. Subsequently, bars are lowered that weld simultaneously the two faces of the mattress material forming thermal bonds in the form of a series of parallel lines (7) between consecutive springs and in a direction perpendicular to the lengthwise strip direction. Simultaneously, the free ends are bonded along the length of the strip (8) of the mattress material. Thus, in one motion all the closed pockets of the strip are formed that have a spring encapsulated in each one. The thermal welding can be done either with direct electrical resistance heating or through thin metallic plates that acquire the appropriate temperature in another work area or utilizing hot air. If the material employed is fabric that cannot accept thermal welding, then attachment mechanisms are used that operate employing clips preferably metallic. These are situated in rows parallel to the respective side of the springs we would like to encapsulate.

There also exist attachment mechanisms for the lengthwise attachment of the edges of the folded fabric mattress material. All these mechanisms are lowered simultaneously achieving the encapsulation of all the springs of the processed strip.

An alternate solution for the construction of the strip is that we can utilize two pieces of fabric, where instead of folding its ends with respect to the width, as it is done with the single piece unit, a long part is placed parallel to another, sandwiching the springs, which after their attachment form the strips. The adherence or attachment of the two pieces in such a case is performed on both the long length edges (8, 9).

After their welding or attachment (clipping) of the two sides of the mattress material, it is necessary with a suitable mechanism to rotate the encapsulated springs (29) by 90°, so that their long direction axis (35) is coincidental with the long direction axis of the created pocket. There the springs can be fully expanded acquiring the appropriate precompression length.

An important embodiment of our invention that simplifies the construction of quality mattresses and creates a new product is the following one:

After the entry of the spring into the pocket, selected consecutive spring turns (11) are compressed with a suitable mechanism towards the bottom wall of the formed pocket, as shown in FIG. (6).

Consecutively, the spring turn that compresses the previous ones and is furthest away from the bottom of the pocket is attached and held firmly at that height to the sidewalls of the pocket (12). This attachment can take place in various ways.

Thus, the first compressed spring turns of the same spring (13) are getting compressed on top of the previously compressed set of spring turns and especially using as the bottom point (12).

When they have reached the desired degree of compression, usually smaller from that one corresponding to the compression level of the submattress, then the upper spring turn of the spring turn set is held firmly to the fabric sidewalls at point (14). Thus, the main mattress is created. With the same way also spring turn set (15) is compressed and is subsequently attached or is encapsulated by attachment and closure of the ends of the pocket.

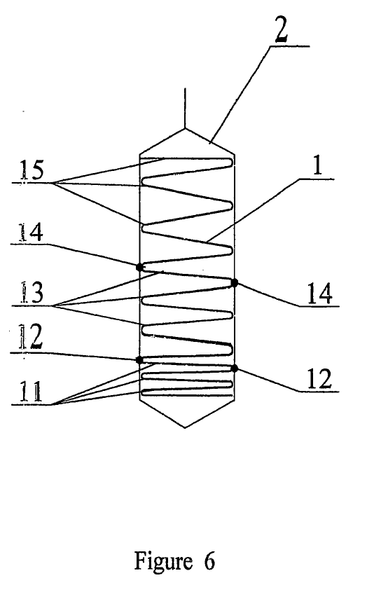

Thus, with only one type of spring at first with uniformly spaced coil turns and only one innerspring mattress, we create many different levels and layers of rigidity in the same mattress, as shown in FIG. 6. These correspond and substitute respective number of separate mattresses that are usually utilized, situated one on top of another. With our method it is possible to achieve the same result as having the three different types of submattress, mattress and top mattress in a composite structure.

The firm attachment of the spring turns to the sidewalls of the pocket can also be accomplished with a series of attachment mechanisms that utilize metallic clips.

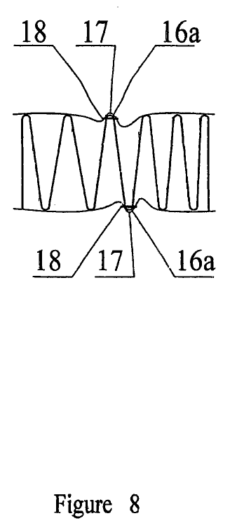

In such a case, that mattress material is getting compressed from the outside towards the inside, as shown in FIG. 8 at points to the right and the left very close to the wire of the spring turn, so that the spring turn can get wrapped over with fabric (17). At this stage, the attachment is activated. The metallic clip (18) attaches strongly the two sides of the fabric (17) encapsulating thus the spring turn (16a).

The spring turn (16a) can be attached in two or more different circumferential points with the fabric and acts as a foundation for the compression of the above it spring turns and as a top compression support for the lower spring turns.

This process is repeated with other sets of spring turns, until the last spring turn is encapsulated within the sealing of the edges of each pocket or by being attached in the same manner to the pocket edges.

We can create many levels of rigidity in a single spring.

The operation of this mattress is as follows:

First, with the weight of the person reclining on the mattress, the spring turns of the first level (15) of rigidity of the mattress recede (top mattress). Subsequently, and after these have reached the degree of pre-compression of the second set of spring turns (13) of the mattress, then the spring turns of the first and second team (15, 13) recede together. When all of these reach the pre-compression degree of the third level (submattress) (11) then all three sets recede as a single spring (15, 13, 11).

The creation of pockets with increased rigidity can be initiated in a reverse fashion, i.e. we create the smallest compression at the bottom of the pocket and the largest at its top end.

An embodiment of this method is to attach the last spring turn (16) directly to the edges of the pocket without attaching the edges between them. Thus the spring remains encapsulated with the edges open. This helps to better aerate the interior of the mattress.

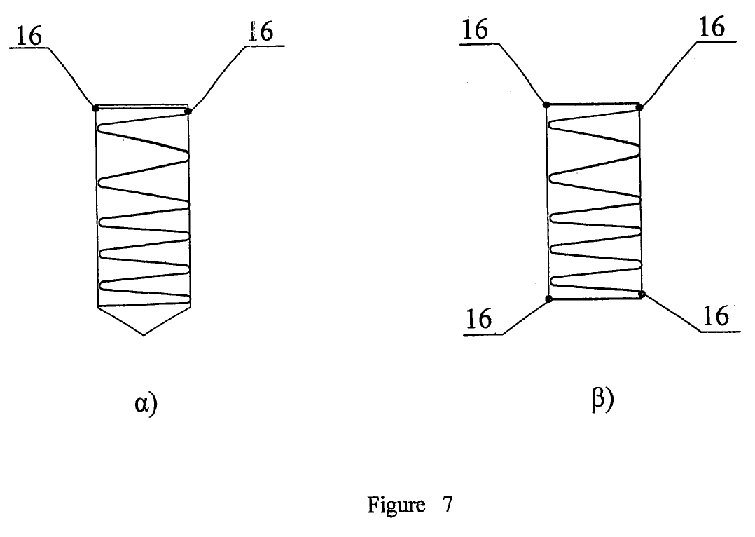

This can be done on both sides of the pocket (FIG. 7b), where during the construction of the strip they both remain open and are attached there to the end turns of the springs. Then the aeration is still further facilitated.

It is possible in the produced strips not to cut the continuation portion of the unraveling fabric and thus to be able to produce a continuous strip. It is also possible to produce directly the desired length of mattress by bonding the strips between them. This is achieved as follows: There are two transport belts parallel to each other in a horizontal plane, operating in a closed circuit, having the same dimension as the width of the mattress. When the strips are led by lengthwise advance at their entry point where the moving belts are adjusted to have a smaller clearance distance between their parallel sides than the height of the encapsulated springs, each strip is being pulled towards the interior space. At the entry work area of the transport belts and at the same level as the lower transport belt there is a lengthwise container (21) that contains hot melt adhesive. There a revolving mechanism emerges from the container equipped with a lengthwise bar and deposits hot adhesive (19) on previously positioned there strip (20) that has entered. On top of that the next strip is situated and adhered, which is also applied over with hot melt adhesive after its placement. Thus, with continuous adhesive application, installations of new strips (3) and step advance of the two transport belt mechanisms, the innerspring mattress (4) is completed.

The strips can be adhered between them in an alternating height differential arrangement, so as to create in the mattress slight symmetrical waveforms. These waveforms impart to the mattress surface an initially greater rigidity, because the body of the reclining person is only in contact with half the total number of springs.

There exists the capability to adhere simultaneously on top of the upper and the lower spring surfaces mattress materials engulfing thus the strips. The adhesive is placed on top of the two upper and lower surfaces of the springs, where with their entry into the system of the two moving transport belts, they are compressed with the upper and lower fabric that run along the surface of the belts and are being pulled in a stepwise fashion backwards, with the advancement of each new strip. The mattress materials unravel from two rolls, an upper and a lower one. At their exit from this assembly system there exists a vertical cutting mechanism that cuts the fabric up and down, separating each mattress from another.

There exists the capability to produce innerspring mattresses that are not separate entities at their exit but to have them pulled through the continuous mattress material stock that connects them by the two rolling cylinders of a mattress-packaging machine in a continuous form, getting compressed and produced in rolls.

In such a case, paper is saved that would be otherwise required to compress and to contain in roll packed form the separate mattresses that need to be transported. Function of the paper is replaced by the upper and lower adhered mattress making material. This also accomplishes the following:

The mattress maker can unravel in order to fabricate the mattresses needed from a continuing mattress stock, extracting the widths necessary. The assortment of lengths of the mattresses that in the roll comprise the width dimension, are usually small in number and with small variations, e.g. varying from 175 cm to 200 cm, while the widths vary from e.g. 70 cm up to 200 cm.

Thus, having in storage 3 or 4 rolls of different lengths, one is able to isolate from these the needed widths covering the wide range of mattress dimensions. In this manner, the need for inventory of large number of mattresses of various sizes is avoided.

Advantages of Our Method

1. The main advantage is the large productivity of the proposed machine.

2. The employment of as many spring coilers as the springs in each side of the produced mattress contributes to the above mentioned productivity in whichever mattress length production is running on.

3. The different spring coilers can produce the desirable lateral zones of varying rigidity without extra adjustment effort, as they are in the process of producing the springs of the whole row.

4. There exists the capability, to operate having e.g. 30 or 100 spring coilers. Thus, for small diameter springs the number of produced pocketed springs per minute is not reduced but rather it is multiplied analogously.

5. The capability to produce zones of varying rigidity in the same encapsulated spring provides thus in the produced mattress the advantage to exhibit simultaneously the rigidity characteristics available in submattress, mattress and top mattress composite structures.

6. Another advantage is also the fact that the machine integrates the processed mattress component products into ready mattress format having as a selectable option, via the computer, the option to adhere between strips or to adhere the strips with the upper and lower sheets or in combination of these methods.

7. The attachment of the end spring turns on one or both of the open ends of the pockets creates for the first time perfect conditions for aeration.

8. The adherence of consecutive strips between them in a sequence with a height differential arrangement provides an additional comfort level with small rigidity felt on the body of the reclining person.

9. The capability to produce the final product in a continuous length stack provides savings from the non-utilization of the necessitated paper.

10. The capability that the mattress maker has to cut, according to the needs arising, the respective widths of mattresses helps to have only a few rolls with different length sizes in the storage area, and as a result minimizes the logistics costs associated with orders having different size requirements.

11. A very significant innovative aspect in the above described method is that it can process non woven sheets but also woven that are highly in demand for their ecological compatibility aspects.

Application of the Method

The machine operator programs the daily production schedule. The length and the width of the mattress as well as the number of springs is determined, with which the strips are to be constructed for that side.

Programmably the operational variables for the lengthwise bar (26) are inputs that determine the diameter of the spring that is to be produced. In the same manner, the movement actions are programmed that set the pitch of the springs. Automatically, the number of machines that need to operate is set. In such a case, the other valves of the offline spring coiler machines remain closed and do not transmit hydraulic or pneumatic pressure to actuate the wire advance.

It is also determined whether the springs have to undergo thermal processing or not, traveling through a thermal chamber that is then set in operation, warmed up with one of the known methods.

Consequently, after the production of the springs, the advance of the wires is halted, by raising the rollers. This is being accomplished with the temporary interruption of the transmission of pressure by the actuating valves. This could also be done by halting the motor that provides motion to the common axle of the rollers. At that point, the cutters are energized that cooperate. Subsequently, the springs moving in parallel rows as they are being produced, perpendicular to their motion direction, enter the thermal processing area. This chamber has the appropriate length and the respective temperature in order to thermally process the springs. Subsequently, the springs after being cooled with air, are led to the position where each spring will follow its own trajectory of approach or recession from neighboring springs. For this reason there exist an equal in number transport linear systems that have their one end fixed at a stable position, but can rotate with respect to that position. The other end of the transport system can move sideways and can be stabilized at the positions that the springs need to have before their entry into mattress material strips.

Subsequently, all the springs, being pushed by a common mechanism (28) are fully compressed. In that position they are picked up in a compressed form by thin fork like mechanisms (20a) of a common mechanism that lead them within lengthwise strips of mattress material (5). The strip can be positioned with its large dimension perpendicular to the movement direction of the fork-like pick-up mechanisms, whereas upon in contact with these mechanisms at its middle section it is forced to be folded up with respect to its width and to thus cover the springs and the forklike mechanism. At that point welding or attachment mechanisms are lowered, which compress the two surfaces of the material in all the lengthwise sides of the springs. The spring pick-up mechanisms retract (20a), releasing the springs that are held compressed by the welding system. Moreover, the free lengthwise side of the strip is pressed with the lengthwise welding-attachment device when the forklike mechanisms withdraw. Then welding (7, 8) or attachment is done simultaneously to form all the pockets. Subsequently, with a suitable mechanism the springs that are situated with their axis perpendicular (29) to the lengthwise surface area of the strip are rotated by 90°, so that their axes coincide with the longitudinal axes of the formed pockets (30). Then the strips are led by a carrier that has sets of grippers, maintaining their lengthwise form, to the entry area of the assembly machine, where the two moving belts pick up the lengthwise row and hold it in place, so that a lengthwise bar in a revolution type motion, emerging from the hot adhesive container (21), deposits adhesive quantities (19) on the outer surfaces of the protruding sides of the springs. The subsequently produced strip is pushed next to the previously produced one and it is thus adhered. Upon the stepwise retraction of the adhered row to clear the work area the same movements are repeated until the dimensions of the whole mattress under construction are completed.

If it is necessary to adhere at the top and bottom side surfaces of the strip sheets of mattress materials, then through the program, the unraveling of the rolls is activated and also the adherence of the strips onto it. The unraveling mattress materials cover up the upper and lower surfaces of the moving belts and follow the stepwise retraction with every placement and adherence of each new strip. If continuously produced mattresses are scheduled to be packaged, then they are not cut into pieces of appropriate length each, but are packaged continuously in rolls, eliminating the need to use paper for that end.

1. Method of production of innerspring units made of springs that are encapsulated into pockets made of flexible mattress-making material that are connected between them forming strips, which strips are adhered to one another to create mattresses, which can have layers parallel to their main surfaces, each layer with a different rigidity value, which is characterized by the fact that all the springs needed to construct a single strip, whose length corresponds to the length of the side of the produced mattress, are produced simultaneously by equal in number to the springs spring coilers, which produce springs with the same or different rigidity, having a common motion source for their concurrent operation, where the continuous rows of the produced springs may undergo thermal batch processing, entering simultaneously and in a controlled constant arrangement into a special chamber, which is kept at the appropriate temperature, where after their exit by means of suitable mechanisms commences an approach of the trajectories of the springs produced from each spring coiler so as for each spring to acquire with their adjacent springs the necessary distances, which springs are compressed by simultaneous compressive action they are all moved in a parallel arrangement to their final position, which is within a flexible mattress-making material, which being folded at once along its entire length with respect to the middle width axis covers them, where subsequently in case the flexible material is thermally weldable it gets adhered simultaneously at the transverse positions in between springs, and along its lengthwise side, where its free ends are, with an equal in number springs plus one thermal welding devices, creating an equal in number to the springs parallel pockets, where in case the material is non-weldable thermally then they are utilized an equal in number to the springs plus one connecting clipping mechanisms that employ suitable clips, preferably metallic, being capable for the mechanisms of thermal welding or of connection by clipping to move towards one another, creating the necessary each time new dimensions of the pockets, being capable for the lengthwise flexible mattress-making material that is needed for the whole row to consist of two separate and equal in length lengthwise pieces, which after being positioned parallel to one another cover up the row of springs and encapsulate them, where in this case they are thermally welded or clipped also along the second lengthwise free end edge, so as to create the closed pockets, being capable for the lengthwise flexible mattress-making material to have been measured up and cut to the necessary length” and in such a fashion as to arrive at the spring row engagement position where welding or dipping is to take place by moving along its width, being capable for certain turns of each spring after being compressed towards the bottom end of the pocket so as to create the necessary spring rigidity intensity to remain there by attachment of that spring turn immediately higher than the pre-compressed ones through a suitable mechanism onto the sidewalls of the pocket, where the rest spring turns remain with a smaller degree of rigidity, imparting thus in the same spring two different zones of rigidity, where in the mattress that is produced this feature creates layers with different rigidity values parallel to the main surfaces of the mattress, where the continuously produced strips can be adhered to one another by the simultaneous application of hot adhesive quantities on the side cylindrical walls of the previously produced strip of the processed mattress onto which each newly produced strip that does not bear hot adhesive is being compressed against and adhered to, creating thus the final product, being capable for the produced mattresses to be overlaid with woven or non woven mattress-making sheets that are adhered with one of the known methods, where the woven or non woven mattress-making sheets are not cut off, having as a result the production of mattresses in large length stocks.

2. Method of production of innerspring mattresses according to claim 1, which is characterized by the fact that the springs are being produced from spring toilers that are by preference equal in number to the array of springs that are necessary for the creation of one side of the mattress, but are at least more than six spring coilers so as to maintain the massive character of the production, where in this case the simultaneously produced springs when they have completed the count of springs that a whole row necessitates are subsequently led with the necessary groupwise step repetitions through the same operations so as to complete the formation of the strips.

3. Method of production of innerspring mattresses according to claim 1, which is characterized by the fact that one or more intermediate spring turns of the pocketed springs can get compressed with a suitable mechanism towards the bottom end of the pocket and at a desirable depth, then to have attached, with a suitable means onto the sidewalls of the pockets the spring turn immediately on top of these spring turns, encapsulating thus the preceding spring turns so as to create the necessary rigidity creating the first layer of rigidity, where the same process can be repeated with other selectable intermediate spring turns which after again compressing the next group of intermediate spring turns on top of the previously attached spring turn are also held in position, being connected with the pocket sidewalls creating thus a second layer of rigidity, where the remaining spring turns entrapped between the lastly attached spring turn and the closed roof end of the pocket create the last layer of rigidity, so that with the utilization of only one spring multiple layers of rigidity are achieved, which impart to the mattress conditions of sub-mattress, mattress and top mattress composite structures.

4. Method of production of innerspring units according to claim 1, which is characterized by the fact that one or both end spring turns of the pocketed spring are not encapsulated by closing the edges of the pockets but are firmly attached and held circumferentially at the rim edges of the pocket, so that the pocket can remain open at the corresponding side facilitating the aeration of the mattress.

5. Method of production of innerspring units according to claim 1, which is characterized by the fact that there exist equal in number to the encapsulated springs plus one attachment mechanisms that attach with preferably metallic clips simultaneously all the necessitated widthwise and lengthwise sides, where each mechanism is equipped with multiple attachment heads in selected distances between them attaching with multiple attachments the transverse sides of each pocket, as well as respective mechanisms that attach along the length one or both the lengthwise edges of the strip.

6. Method as described in claim 1, which is characterized by the fact that the produced “mattresses that have their top -and bottom surfaces adhered with woven or non woven mattress-making sheets can be not separate pieces but can be produced in a continuous form connected between them through their overlaying sheets and thus in this form to be compressed and packaged into rolls without the need to use strips of paper, where afterwards with gradual unrolling one can severe mattresses of different widths depending on the arising production needs.

7. Method as described in claim 1, which is characterized by the fact that the thermal welding for the simultaneous creation of the pockets and the encapsulation of the springs of the whole strip can be accomplished through electrical resistances that cover all the necessary positions for welding and operate while being heated simultaneously, where as a result the upper and lower sheets of the strip get adhered creating all the necessary pockets and simultaneously encapsulating all the springs.

8. Method as described in claim 1, which is characterized by the fact that the thermal welding for the simultaneous creation of the pockets and the encapsulation of the springs of the whole strip can be accomplished through metallic thin plates that have the shape and length of the surface areas that are to be welded, which thin plates are preheated in another position, transmitting the necessary temperature at the point where they compress simultaneously the whole length of the constructed strip, welding at the transverse and longitudinal positions the non woven sheet, creating thus all the pockets and encapsulating simultaneously all the springs.

9. Method as described in claim 1, which is characterized by the fact that the thermal welding can be accomplished simultaneously in all the necessary points of the strip by forcing hot air through a suitable mechanism, creating as a result the pockets and the encapsulation of all the springs.

10. Method as described in claim 1, which is characterized by the fact that the shapes of the welded positions of the pocket strip can have curved forms or combinations of straight and curved forms that is accomplished by appropriately shaping the thin metallic plates that transfer the heat or in other cases appropriately shaping the respective distribution network of the forced hot air.

11. Method of construction of innerspring mattresses as described in claim 1, which is characterized by the fact that the welded in between them strips can get adhered in a differential height arrangement, placing consecutive rows in an alternate fashion at different height differentials between them, creating thus lengthwise or widthwise waveforms on the whole upper and lower surface of the mattress.

12. Mattress made of springs encapsulated into pockets made of flexible mattress-making material that has multiple layers with different rigidity values, which is characterized by the fact that the layers of different rigidity value are created by only one layer of springs, achieving the creation of layers having different rigidity by the compression of certain spring turns of each spring and their maintenance at that position by their attachment to the pocket sidewalls, where the same method is repeated to create in the same spring second or multiple layers of rigidity, creating thus conditions that exist when mattresses with three different rigidity values are used positioned one on top of the other as a submattress, mattress and top mattress composite structure.

13. Mattress as described in claim 1, which is characterized by the fact that the one end spring turn of the spring is perimetrically attached through a suitable mechanism to the open edges of the pocket, where in the particular case these edges are not adhered or attached between them to form a pocket with closed ends, being capable for the other opposite end spring turn to be attached on the edges of the pocket on the opposite side, when that one is also open in cases where the pocket strip is constructed from two separate lengthwise parts that are adhered or attached only at the widthwise sides of the pockets, creating thus a cylindrical opening that can serve as an aeration channel.

14. Mattress as described in claim 12, which is characterized by the fact that it is feasible after the complete encapsulation of the springs into the pockets to attach with a suitable mechanism the two end spring turns to the non woven sheet of the mattress-making material with which they are in contact, where subsequently, after the spring has been firmly attached on both its sides, appropriate material is removed from the non woven sheet in the two parallel sides of the pocket, creating thus a free passage for aeration.

15. System of mechanisms for the construction of innerspring mattresses made of springs that are encapsulated in pockets of mattress-making material that is thermally weldable or is made of woven material, which is characterized by the fact that all the springs of each row that are needed for the construction of the whole length of the side of the mattress are produced simultaneously by an equal in number to the springs spring coilers that are set in motion by a common axle in order for them to work together, having on top of the set of the rollers that advance the wire compression pistons, each one with its own actuating valve, where through the computer it is programmed how many wires are to be advanced in order to produce the necessary springs each time, where the formation of the pitch of the springs is done by a lengthwise mechanism which acts through a respective set of arms, which compress the produced spring turns, where also the diameter of the produced springs Is created by a respective lengthwise mechanism with a respective set of arms that presses the wires at the entry point of the spring producing work area, where the severance of the wire after the springs are produced is accomplished simultaneously by a common force with mechanical means, being possible for the wires to be cut with hydraulic cutting mechanisms, where in this case each spring collar machine has its own incorporated cutting mechanism that is connected to a common hydraulic pressure source, where subsequently the whole produced row of springs through a suitable transport moving belt passes through an enclosed chamber area that is kept at the proper air temperature suitable for the thermal processing of the springs if that is necessary, where subsequently the springs are advanced each one with a separate transport belt, where these belts are being adjusted so as to approach in distance one another so that the springs can acquire the necessary distances amongst them, where with these distances after being compressed concurrently through a lengthwise mechanism they are subsequently advanced and entered within the lengthwise mattress-making material, where the mattress-making material being folded along its length with respect to its middle width axis covers them up simultaneously, where subsequently If the employed mattress material is thermally weldable then a lengthwise bar is lowered that bears an equal in number to the springs plus one widthwise thermal welding mechanical systems parallel to one another, having as well lengthwise thermal welding systems to achieve the welding of the two free ends of the folded mattress material, where as a result simultaneous thermal welds, are achieved and the formation of all the pockets, being capable for the bar in case the mattress material is not thermally weldable to bear in the respective positions attachment mechanisms that connect the two sides of the mattress material through clips preferably metallic that are activated simultaneously, where each connection clip is leaving these mechanisms with its two ends facing downwards, where while penetrating the mattress material is pushed against a metallic surface suitably formed so that the ends are forced to be bent in a desirable direction, where after getting compressed they become flat creating widthwise and lengthwise attachment connection lines, where subsequently the springs are situated inside the pockets held compressed with their axis oriented at a direction perpendicular to the side surfaces of the pocket, where through a suitable mechanism the springs are forced to rotate by 900 so that by expansion their axes coincide with the longitudinal axes of the formed pockets, where the strip created is advanced to come into contact with the previously produced strip, onto which and especially at the protruding points where contact takes place hot adhesive quantity is applied so as to consecutively adhere the strips, where the hot adhesive is originating from a lengthwise container that includes a lengthwise mechanism that in a rotational motion applies simultaneously all tile positions or the encapsulated springs of the strip the necessitated quantity of adhesive material producing thus with repetition of the above described sequences the complete mattress product.

16. Method of production of innerspring units according to claim 3, which is characterized by the fact that one or both end spring turns of the pocketed spring are not encapsulated by closing the edges of the pockets but are firmly attached and held circumferentially at the rim edges of the pocket, so that the pocket can remain open at the corresponding side facilitating the aeration of the mattress.

17. Method as described in claim 8, which is characterized by the fact that the shapes of the welded positions of the pocket strip can have curved forms or combinations of straight and curved forms that is accomplished by appropriately shaping the thin metallic plates that transfer the heat or in other cases appropriately shaping the respective distribution network of the forced hot air.

18. Method as described in claim 9, which is characterized by the fact that the shapes of the welded positions of the pocket strip can have curved forms or combinations of straight and curved forms that is accomplished by appropriately shaping the thin metallic plates that transfer the heat or in other cases appropriately shaping the respective distribution network of the forced hot air.

19. Mattress as described in claim 13, which is characterized by the fact that it is feasible after the complete encapsulation of the springs into the pockets to attach with a suitable mechanism the two end spring turns to the non woven sheet of the mattress-making material with which they are in contact, where subsequently, after the spring has been firmly attached on both its sides, appropriate material is removed from the non woven sheet in the two parallel sides of the pocket, creating thus a free passage for aeration.
